(19) United States
(12) Patent Application Publication
(10) Pub. No.: US 2009/0240845 A1
(43) Pub. Date: Sep. 24, 2009

(54) Audio help system

(75) Inventors: Michael A. Wiegand, Birmingham, MI (US); Christopher M. Kurpinski, Berkely, MI (US); Justin P. McBride, West Bloomfield, MI (US); Thomas J. Keeling, Plymouth, MI (US); Toshihiro Wakamatsu, West Bloomfield, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/077,454

(22) Filed: Mar. 18, 2008

(51) Int. Cl. G06F 13/10

(52) U.S. Cl. 710/16

(57) ABSTRACT

A communication system includes a communication device and a controller that detects input supplied to a vehicle subsystem. The controller consequently causes the communication device to output operational instruction information about the subsystem.

### FIELD

The present disclosure relates to a vehicle and, more particularly, to a vehicle audio help system.

### BACKGROUND

The statements in this section merely provide background information related to the present disclosure and may not constitute prior art.

Vehicles have an increasing number of features and subsystem components. For instance, vehicles can include wiper systems, interior light systems, exterior light systems, door systems, lock systems, navigation systems, climate control systems, seat adjustment systems, steering column adjustment systems, audio systems, video systems, mirror adjustment systems, safety systems, engine power delivery systems, ignition systems, and many other systems that increase value, safety, and/or convenience for the vehicle.

Typically, the vehicle subsystem(s) include a number of features. For instance, a wiper system can have a variety of wiping frequency settings, and/or can include an automatic moisture detection setting for automatically controlling wiping according to detected precipitation on the windshield. The subsystem(s) can even be programmable. For instance, seat position, mirror position, radio stations, and the like can be programmed into computerized memory according to the user's desires. Then, the user can cause the subsystem to recall the programmed seat position, mirror position, radio station, etc. when desired.

As such, learning how to operate the vehicle subsystems can be complex, confusing and frustrating. Vehicles often include a corresponding user manual, which describe the various features of the vehicle subsystems and include various operational instructions and/or warnings about the subsystems. However, consulting the user manual can be inconvenient and time consuming.

### SUMMARY

A communication system is disclosed for a vehicle with at least one subsystem having an input device with which a user supplies an input. The communication system includes a communication device and a controller that detects the input supplied with the input device and consequently causes the communication device to output operational instruction information about the subsystem.

A vehicle is also disclosed that includes a communication device and at least one subsystem with an input device with which a user supplies an input. The vehicle further includes a controller that detects the input supplied with the input device and consequently causes the communication device to output operational instruction information about the subsystem.

Furthermore, a vehicle is disclosed that includes a communication device with at least one of a speaker and a video screen. The vehicle also includes at least one subsystem. The subsystem can be a wiper system, an interior light system, an exterior light system, a door system, a lock system, a navigation system, a climate control system, a seat adjustment system, a steering column adjustment system, an audio system, a video system, a mirror adjustment system, a safety system, an engine power delivery system, or an ignition system. The subsystem has an input device with which a user supplies an input. The vehicle further includes a portable device and a receiver system that detects when the portable device is within a predetermined range of the vehicle. Moreover, the vehicle includes a controller that activates when the receiver system detects that the portable device is within the predetermined range of the vehicle and that deactivates when the receiver system detects that the portable device is outside the predetermined range of the vehicle. The controller additionally detects the input supplied with the input device and consequently causes the communication device to output operational instruction information about the subsystem.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of a vehicle with a communication system according to the present disclosure;

FIG. 2 is a schematic illustration of the communication system of the vehicle of FIG. 1; and

FIG. 3 is a flowchart illustrating a method of operating the communication system of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

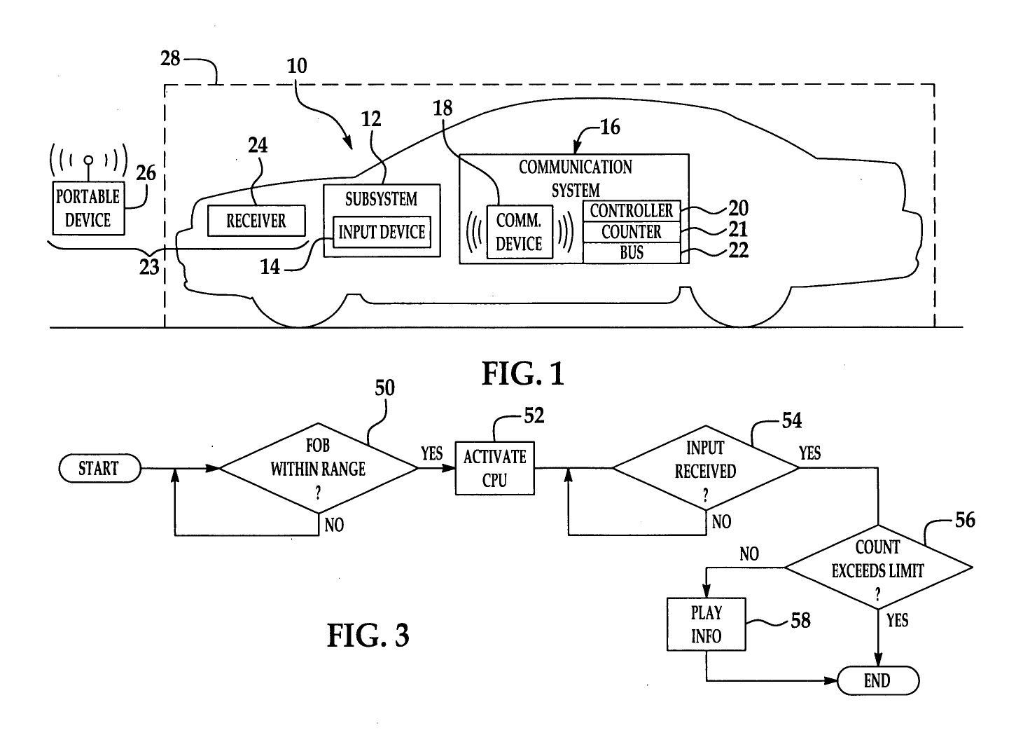

Referring initially to FIG. 1, a vehicle 10 is illustrated. The vehicle 10 includes at least one subsystem 12. The subsystem 12 includes an input device 14 with which a user (not shown) supplies an input. For example, in one embodiment, the subsystem 12 is a windshield wiper system for wiping the windshield of the vehicle. Also, in one embodiment, the input device 14 includes one or more buttons (not shown) that can be manipulated (i.e., pressed) by the user to supply the input. In one embodiment, the user turns the windshield wipers on and off, adjusts the wiping frequency, and/or adjusts a moisture sensitivity (i.e., supplies an input) for the wiping system by pressing one or more of the buttons of the input device 14. It will be appreciated that the subsystem 12 could be of any suitable type without departing from the scope of the present disclosure. It will also be appreciated that the input device 14 could be of any suitable type (e.g., buttons, knobs, dials, touch screens, etc.) without departing from the scope of the present disclosure.

Furthermore, the vehicle 10 includes a communication system, generally indicated at 16. The communication system 16 includes a communication device 18. The communication device 18 outputs information to the user and can be of any suitable type, such as an audio speaker, a video screen, a combination audio/video unit, etc. It will be appreciated that the communication device 18 could be a stand-alone communication device 18 dedicated solely to the communication system, or the communication device 18 could be incorporated in a separate system, such as a speaker or video screen of an entertainment system of the vehicle 10. Moreover, the communication device 18 could be located inside the vehicle 10 such that information from the communication device 18 is output to the interior of the vehicle. Also, the communication device 18 could be located outside the vehicle 10 so as to output the information to an area outside the vehicle 10.

The communication system 16 also includes a controller 20. The controller 20 can be of any suitable type, and the controller 20 can include circuitry, a central processing unit (CPU), a processor, programmed logic, computerized memory, and/or the like. It will be appreciated that the controller 20 could be a dedicated system for controlling only the communication system 16, or the controller 20 could be associated with controllers for other systems of the vehicle 10, such as the engine control unit, and the like.

In general, when the user (not shown) supplies an input using the input device 14, and the controller 20 detects the input supplied with the input device 14. The controller 20 consequently outputs a control signal to the communication device 18, which causes the communication device 18 to output information about the subsystem 12 to the user. In other words, use of the subsystem 12 is detected due to use of the input device 14 by the user, and the communication system 16 responds by outputting information about the subsystem 12 being used. In one embodiment, the communication device 18 outputs operational instruction information about the subsystem 12 being used. Furthermore, in one embodiment, the communication device 18 provides information about how to program the subsystem 12. Also, in one embodiment, the communication device 18 outputs warning information about the subsystem 12. As such, the user is automatically provided with helpful information about the subsystem 12 in a convenient and time saving manner.

In one embodiment, the controller 20 is in communication with a bus 22. When the user provides input via the input device 14, the subsystem 12 becomes active on the bus 22, and the controller 20 detects that the subsystem 12 is active on the bus 22. In response, the controller 20 outputs the control signal to the communication device 18, causing the communication device 18 to output the information about the subsystem 12. However, it will be appreciated that the controller 20 can detect the input supplied with the input device 14 in any suitable fashion without departing from the scope of the present disclosure.

Also, in the embodiment shown, the controller 20 includes a counter 21. The counter 21 records a number of times that the communication device 18 outputs the information. Furthermore, the controller 20 disables output of the information from the communication device after the counter 21 records a predetermined number of times that the information has been outputted. In one embodiment, once the subsystem 12 has been used a predetermined number of times, the information is no longer output from the communication device 18. It is likely that the user learns how to operate the subsystem 12 after a certain number of uses, and thus, the controller 20 disables output of the operational instruction information once the subsystem 12 has been used the predetermined number of times.

More specifically, in one embodiment, when the user first uses the subsystem 12, the communication device 18 outputs information about the subsystem 12, and the counter 21 increases its count by one. When the user uses the subsystem 12 a second time, the communication device 18 again outputs information about the subsystem 12, and the counter 21 increases its count by one. This cycle repeats for a predetermined number of times (e.g., three times). Once the count of the counter 21 reaches the predetermined number, the controller 20 disables output of the information such that the user can subsequently use the subsystem 12 without the communication device 18 outputting information about the subsystem 12. Thus, the communication system 16 can be useful for learning information about the subsystem 12 when the vehicle 10 is new to the user; however, once the user is better acquainted with the subsystem(s) 12 of the vehicle 10, the communication system 18 no longer outputs information about the subsystem(s) 12.

In one embodiment, the communication system 16 is incorporated into a vehicle 10 that includes a smart key system, generally indicated at 23. The smart key system 23 can be of any suitable type, such as those systems described in U.S. Patent Publication No. 2004/0119628, published Jun. 24, 2004, to Kumazaki et al., and/or U.S. Patent Publication No. 2006/0066439, published Mar. 30, 2006, to Keeling et al., which are hereby incorporated by reference in their entirety. The smart key system 23 includes a receiver 24 and a portable device 26. The portable device 26 can be carried by the user instead of a conventional key. In one embodiment, the portable device 26 includes a transmitter for transmitting signals that are detected by the receiver 24. The receiver 24 detects whether the portable device 26 is within a predetermined range (illustrated by broken line 28) of the vehicle 10. In other words, the receiver 24 detects whether the user is located near the vehicle 10 by detecting whether the portable device 26 is located near the vehicle 10.

When the receiver 24 detects that the portable device 26 is within the range 28, the smart key system 23 can affect operation of the vehicle 10 in a variety of ways. For instance, once the portable device 26 is within the range 28, the door locks (not shown) of the vehicle 10 automatically unlock. In another embodiment, the door locks unlock only once the portable device 26 is within the range 28 and the user touches one of the door handles. Also, in one embodiment, once the portable device 26 is within the range 28, the user can start the engine of the vehicle 10 by pressing a button (not shown) (i.e., without having to insert a key into the ignition). It will be appreciated that the smart key system 23 can have various other functions without departing from the scope of the present disclosure. Furthermore, the range 28 can be of any suitable size relative to the vehicle 10 without departing from the scope of the present disclosure.

In the embodiment shown, operation of the communication system 16 depends on whether the receiver 24 detects that the portable device 26 is within the range 28 as will be described in greater detail below. For instance, in one embodiment, the controller 20 includes a central processing unit (CPU) that activates (i.e., energizes) when the portable device 26 is within the range 28; also, the CPU of the controller 20 deactivates (i.e., de-energizes) when the portable device 26 is detected outside the range 28 to thereby save energy. Also, in one embodiment, the communication system 16 only outputs the information from the communication device 18 when the portable device 26 is detected within the range 28. It will be appreciated, however, that the communication system 16 could operate independent of the smart key system 23 without departing from the scope of the present disclosure. Furthermore, in one embodiment, the vehicle 10 does not include a smart key system 23.

Referring now to FIG. 2, one embodiment of the vehicle 10 and its plurality of subsystems 12a-12o are illustrated. It will be appreciated that the subsystems 12a-12o listed are merely exemplary, and the vehicle 10 could include any number of subsystems 12a-12o, and the subsystems 12a-12o could be of any suitable type without departing from the scope of the present disclosure.

The subsystems 12a-12o each includes at least one corresponding input device 14a-14o. The input device 14a-14o of each subsystem 12a-12o is manipulated by the user to turn on the respective sub-system 12a-12o, adjust the operation of the sub-system 12a-12o, or for any other input relating to the respective subsystem 12a-12o. The input device 12a-12o could be of any suitable type, such as a button, a switch, a dial, a knob, a lever, a touch-screen, and the like. It will also be appreciated that one or more subsystems 12a-12o could rely on the same input device 14a-14o for control thereof.

In the embodiment shown, the vehicle 10 includes a wiper system 12a. The wiper system 12a can be of any suitable type known in the art. The wiper system 12a is used to wipe the windshield of the vehicle 10. The wiper system 12a has a variety of frequency settings. Also, in one embodiment, the wiper system 12a includes a moisture detection device, which automatically causes the wipers to wipe the windshield when moisture is detected on the windshield. Furthermore, in one embodiment, the wiper system 12a automatically adjusts the frequency of the wiper system according to the amount of moisture detected on the windshield. The input device 14a is used to turn the wipers on and off, adjust the wiping frequency, turn the moisture detection device on and off, adjust the sensitivity of the moisture detection device, and the like. When the user manipulates the input device 14a, the controller 20 detects use of the wiper system 12a, and the controller 20 causes the communication device 18 to output information about the wiper system 12a. For instance, in one embodiment, the communication device 18 plays an audio recording and/or plays a prerecorded video describing the features of the wiper system 12a, explains how the controls work for adjusting operation of the wiper system 12a, and the like. More specifically, in one embodiment, when the controller 20 detects use of the wiper system 12a, the communication device 18 outputs an audio message (with or without accompanying video) stating “to change the sensitivity of the moisture detection system, rotate the inner ring on the wiper switch.” Accordingly, the user will be educated about the different features and/or controls of the wiper system for more effective use thereof.

In one embodiment, the communication device 18 outputs the information, and the counter 21 increases its count by one. The counter 21 subsequently increases its count every time the wiper system 12a is additionally used and the communication device 18 additionally outputs the information. Once the wiper system 12a has been used a predetermined number of times, the controller 20 disables output of the information from the communication device 18.

Furthermore, in the embodiment shown, the vehicle 10 includes an interior light system 12b with one or more input devices 14b. Once the controller 20 detects use of the interior light system 12b, the communication device 18 outputs information regarding the interior light system 12b. In one embodiment, the communication device 18 outputs information about how to turn interior lights on and off. In one embodiment, the interior lights are programmable, and the length of time that the interior lights remain lit after the engine is turned off can be programmed by the user. In this embodiment, the communication device 18 outputs information about how to program the interior light system 12b. The controller 20 can also limit the amount of times that the communication device 18 outputs information about the interior light system 12b using the counter 21 as described above.

Moreover, the vehicle 10 includes an exterior light system 12c with at least one input device 14c. The communication device 18 outputs information about the exterior light system 12c once use of the exterior light system 12c is detected. In one embodiment, the user receives audio and/or video information regarding how to turn the exterior lights of the vehicle 10 on and off, and/or how to program the exterior lights of the vehicle 10. The controller 20 can also limit the amount of times that the communication device 18 outputs information about the exterior light system 12c using the counter 21 as described above.

Additionally, the vehicle 10 includes a door system 12d. The door system 12d could be of any suitable type, such as a swinging door, a sliding door, a rear gate, and the like. The door system 12d can also include retractable windows and actuators for opening and closing the windows. The door system 12d also includes an input device 14d such as a door handle, a button, and/or any suitable input device 14d that can be manipulated by the user to open and close the doors and/or windows of the door system 12d. When use of the door system 12d is detected, the communication device 18 outputs information about how to operate and about the features of the doors system 12d. Furthermore, in one embodiment, the door system 12d includes one or more actuating systems (not shown) for automatically opening and closing (i.e., actuating) the doors of the vehicle 10. When the controller 20 detects that the doors of the door system 12d are opening or closing automatically, the communication device 18 outputs a warning message to stand clear of the moving door. In one embodiment, this warning information is output from the communication device 18 so that the information can be heard/seen outside and inside the vehicle 10. The controller 20 can also limit the amount of times that the communication device 18 outputs information about the door system 12d using the counter 21 as described above.

Furthermore, the vehicle 10 includes a lock system 12e with one or more corresponding input devices 14e. The lock system 12e locks and unlocks the doors of the vehicle 10. When the lock system 12e is used, the controller 20 causes the communication device 18 to output information about the lock system 12e. For instance, the communication device 18 outputs information regarding how to lock and unlock the doors. In one embodiment, once the receiver 24 detects that the portable device 26 is within the range 28 of the vehicle 10, the communication device 18 outputs information explaining how to unlock the doors of the vehicle 10. Also, in one embodiment, if the portable device 26 is not detected within the range 28 and a door handle is used to unlock or open a door of the vehicle 10, the communication device 18 outputs a message stating “the smart key FOB is not detected.” The controller 20 can also limit the amount of times that the communication device 18 outputs information about the lock system 12e using the counter 21 as described above.

Additionally, the vehicle 10 includes a navigation system 12f and at least one input device 14f. The navigation system 12f can display maps of a desired area, can list directions to and from a desired location, list areas of interest surrounding the vehicle 10, and the like. When use of the navigation system 12f is detected, the controller 20 causes the communication device 18 to output information about the navigation system 12f, such as information on how to use the navigation system 12f, the different settings of the navigation system 12f, as well as how to program the navigation system 12f. The controller 20 can also limit the amount of times that the communication device 18 outputs information about the navigation system 12f using the counter 21 as described above.

Furthermore, the vehicle 10 includes a climate control system 12g and one or more input devices 14g. The climate control system 12g is useful for adjusting the temperature inside the vehicle 10, activating window defroster systems, and the like. When the controller 20 detects use of the climate control system 12g the communication device 18 outputs information on how to use the climate control system 12g, how to program the climate control system 12g, and the like. Also, the counter 21 can be used to limit the number times that the information is output as described above.

The vehicle 10 also includes an engine power delivery system 12h and at least one corresponding input device 14h. The engine power delivery system 12h allows control of the power delivery from the engine of the vehicle 10 to the wheels of the vehicle 10. For instance, the engine power delivery system 12h allows four-wheel drive to be turned on and off, allows a traction control system to be turned on and off, and the like. When the input device 14h is manipulated by the user, the controller 20 detects this use and causes the communication device 18 to output information about the engine power delivery system 12h. For instance, in one embodiment, the communication device 18 outputs information about how to operate and adjust the settings of the engine power delivery system 12h. Also, in one embodiment, the communication device 18 outputs warning information about the engine power delivery system 12h, such as warnings about loss of traction under certain driving conditions, warnings against damage to the power train of the vehicle 10, and the like. Also, the counter 21 can be used to limit the number times that the information is output as described above.

The vehicle 10 also includes a seat adjustment system 12i and at least one corresponding input device 14i. The seat adjustment system 12i includes an actuator and/or the like for adjusting the position of the seat of the vehicle 10. When the input device 14i is manipulated, the controller 20 causes the communication device 18 to output information about the seat adjustment system 12i. For instance, the communication device 18 outputs information about the various ways of positioning the seat of the vehicle 10. In one embodiment, the communication 18 also outputs warning information about how to position seats and headrests for increased safety, proper use of child seats, and the like. In one embodiment, the communication device 18 also includes information on how to program a position of the seat into computerized memory using the seat adjustment system 12i. Furthermore, the counter 21 can be used to limit the number of times that the information is output as described above.

Additionally, the vehicle 10 also includes a steering column adjustment system 12j and at least one corresponding input device 14j. The steering column adjustment system 12j includes an actuator and/or other suitable type of system for adjusting the position of the steering column of the vehicle 10. When the input device 14j is manipulated to change the position of the steering column, the controller 20 detects that the system 12j is being used, and causes the communication device 18 to output information about the steering column adjustment system 12j. In one embodiment, for instance, the communication device 18 outputs information about how to change the position of the steering column using the steering column adjustment system 12j. Also, in one embodiment, the communication device 18 outputs information on how to program a position of the steering column into computerized memory using the steering column adjustment system 12j. Furthermore, the counter 21 can be used to limit the number of times that the information is output as described above.

Moreover, the vehicle 10 also includes an audio entertainment system 12k and at least one corresponding input device 14k. The audio entertainment system 12k can include speakers, a compact disc player, a cassette tape player, an MP3 player, and/or any other suitable audio device. When the input device 14k is manipulated to operate the system 12k, the controller 20 causes the communication device 18 to output information about the audio system 12k. For instance, the communication device 18 can output information on how to turn the audio system on and off, how to adjust volume, how to program stations on the radio of the audio system 12k, how to change tracks on a CD, and/or any other suitable information for operation of the audio system 12k. Furthermore, the counter 21 can be used to limit the number of times that the information is output as described above.

The vehicle 10 further includes a video entertainment system 12l with at least one corresponding input device 14l. The video entertainment system 12l includes a video screen, a DVD player, a video cassette recorder, and/or any other suitable video media player. When the input device 14l is manipulated, the controller 20 causes the communication device 18 to output information about the video system 12l. For instance, the communication device 18 can output information on how to turn the video system on and off, how to adjust volume, how to fast forward video, and/or any other explanation of the operation of the video system 12l. Furthermore, the counter 21 can be used to limit the number of times that the information is output as described above.

Moreover, the vehicle 10 also includes a mirror adjustment system 12m with at least one corresponding input device 14m. The mirror adjustment system 12m includes an actuator and/or any other suitable type of component for adjusting the position of one or more mirrors in the vehicle 10. The input device 14m is manipulated by the user to cause the actuator to adjust the position of the mirror adjustment system 12m. When the input device 14m is manipulated, the controller 20 causes the communication device 18 to output information about the mirror adjustment system 12m. For example, the communication device 18 outputs information on how to change the position of the mirrors using the input device 14m. Furthermore, in one embodiment, the communication device 18 outputs information about how to program a position of the mirrors into computerized memory using the input device 14m of the mirror adjustment system 12m. Furthermore, the counter 21 can be used to limit the number of times that the information is output as described above.

The vehicle 10 further includes a safety system 12n. The safety system 12n can include airbags, seatbelts, belt tensioners, and/or any other suitable safety device. The safety system 12n also includes an input device 14n such as a button for turning the safety system on and off. When the input device 14n is manipulated by the user, the controller 20 causes the communication device 18 to output information about the safety system 12n. For instance, the communication device 18 explains the purpose of the safety system, how to turn the safety system on and off using the input device 14n, and/or a warning regarding the use or non-use of the safety system 12n. Furthermore, the counter 21 can be used to limit the number of times that the information is output as described above.

Furthermore, the vehicle 10 further includes an ignition system 12o. The ignition system 12o is useful for starting and stopping the engine of the vehicle 10. The ignition system 12o includes an input device 14o, such as a button, and/or a turnable keyhole. When the input device 14o is manipulated to start the engine, the controller 20 causes the communication device 18 to output information about the ignition system 12o. For instance, the communication device 18 outputs information about how to start and/or stop the engine of the vehicle 10. Also, in one embodiment, when the receiver 24 detects that the portable device 26 is within the predetermined range 28, the communication device 18 outputs information about the smart key system 23 in relation to the ignition system 12o. For instance, in one embodiment, the communication device 18 states “the portable device 26 has been detected. Please apply pressure to the brake pedal before starting the vehicle.” Furthermore, the counter 21 can be used to limit the number of times that the information is output as described above.

Also, in one embodiment, the communication system 16 requires input from a plurality of input devices 14a-14o before the communication device 18 outputs the information. For instance, information is output from the communication device 18 only after a door handle has been touched and a occupant sensor detects that an occupant is sitting within the vehicle 10.

Moreover, in one embodiment, once the portable device 26 is detected within the range 28, and the controller 20 detects that the user is sitting in the vehicle 10 (e.g., via an occupant sensor, etc.) the communication device 18 states “Please apply pressure to the brake pedal before starting the vehicle. Otherwise, with your foot off the brake pedal, pressing the start button once will place the vehicle in accessory mode so that you can operate the accessories of the vehicle. Pressing the start button again will place the vehicle in ignition mode so that you can operate all of the systems of the vehicle with the engine off. Pressing the start button once more will return the vehicle to off mode.”

In one embodiment, the communication system 16 is adjustable and programmable. In other words, the user can adjust the volume of the information output from the communication device 18, and/or pause the information, rewind the information, fast forward the information, etc. Additionally, the user can enable or disable the communication system 16 at any time, program which subsystem 12 will trigger the information from the communication system 16, and the like. Furthermore, the user may activate and obtain the information from the communication system 16 at any time. Also, the user can program how many times use of the subsystem 12 will trigger output of the information from the communication device 18. More specifically, the controller 20 can be programmed in association with the counter 21 such that the communication device 18 outputs information a desired number of times before information output is disabled. It will be appreciated that the controller 20 could be programmed in this fashion for all subsystems 12 at once, or the controller 20 could be programmed in this fashion for individual subsystems 12 according to the desires of the user. Specifically, in some embodiments, the user can program the controller 20 such that the communication system 16 outputs information about each subsystem 12 five times before output is disabled. In other embodiments, the user can program the controller 20 such that the communication system 16 outputs information about the interior light system 12b only once, and the user can program the controller 20 such that the communication system 16 outputs information about the navigation system 12f six times. However, it will be appreciated that the controller 20 enables the user to program output of the information to any desired number of times and for any of the subsystems 12.

In addition, in one embodiment, the communication system 16 is user-interactive. More specifically, in one embodiment, the communication system 16 includes voice recognition software, allowing the user to speak commands that are recognized by the communication system 16 for interacting with the information output from the communication device 18. In another embodiment, the communication system 16 includes a touch screen allowing the user to input commands by touching the touch screen to thereby navigate and thereby control the communication system 16. For instance, the communication device 18 can ask whether the user understands the information previously output, and the user can specify whether or not the information was understood. The communication device 18 can then repeat the information if the user did not understand.

Moreover, in one embodiment, the communication system 16 can communicate with an external computer (e.g., a personal computer) outside of the vehicle 10. The communication system 16 transmits the information about the subsystems 12a-12o to the external computer. As such, the user can learn about the subsystems 12a-12o of the vehicle 10 at their own convenience outside the vehicle 10.

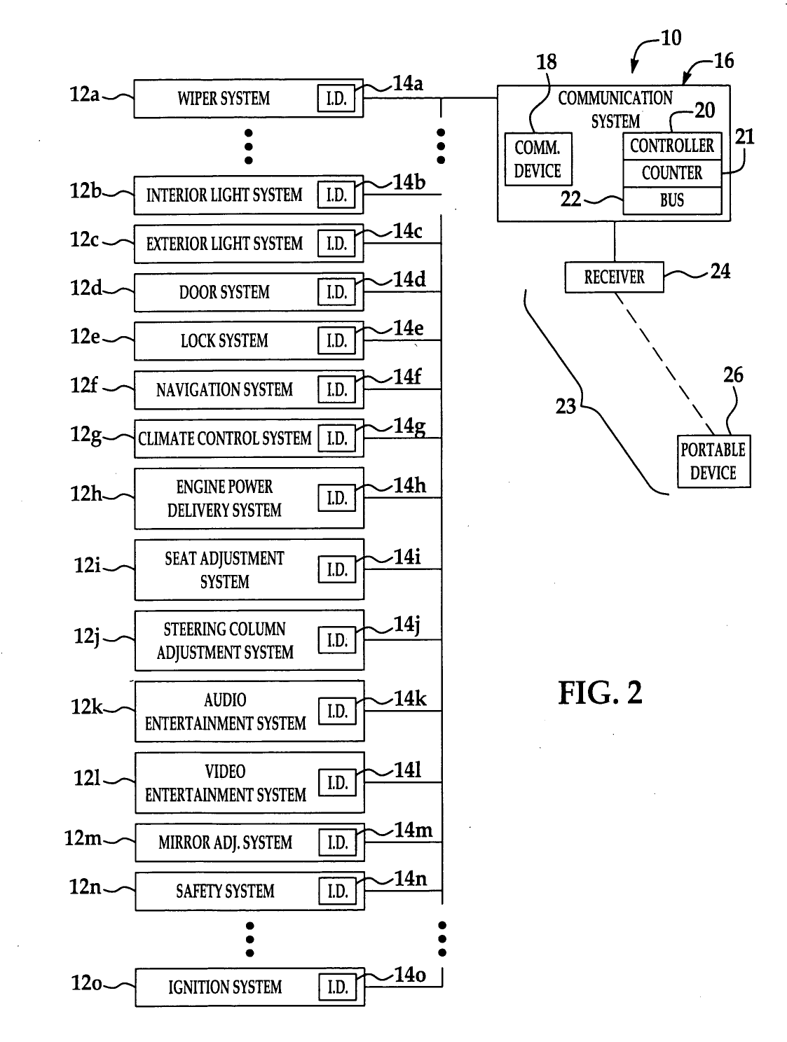

Referring now to FIG. 3, one embodiment of a method of controlling the communication system 16 is illustrated. The method begins in decision block 50, in which it is determined whether the portable device 26 is within the range 28 of the vehicle 10. If the portable device 26 is detected outside the range 28, the method repeats decision block 50. If the portable device 26 is detected within the range 28, the method continues in step 52, in which the CPU of the communication system 16 is activated. It will be appreciated that the combination of steps 50 and 52 allow the CPU to deactivate when the portable device 26 is outside the range 28. In other words, power can be conserved when the user walks away from the vehicle 10, and the CPU of the communication system 16 can automatically activate when the user approaches the vehicle 10.

The method continues in decision block 54, in which it is detected whether input is received from any one of the input devices 14a-14o. If no input has been received, the decision block 54 is repeated. Once an input is received, the method continues in decision block 56.

In decision block 56, it is determined whether the count of the counter 21 exceeds a predetermined limit. In other words, it is determined whether the information about the subsystem 12 should be outputted based on the number of times that the subsystem 12 has been operated by the user. In one embodiment, the count limit is different for one or more subsystems 12a-12o. Also, in one embodiment, the count limit is infinite (i.e., there is no limit) for outputting information regarding certain ones of the subsystems 12a-12o. For instance, warning information is always output from the communication device 18 when a door of the door system 12d is opening and/or closing, and/or safety information and warnings are always output from the communication device 18 when the safety device 12n is turned on and/or off.

If the count exceeds the predetermined limit in decision block 56, the method ends. However, if the count does not exceed the limit in decision block 56, step 58 follows. In step 58, the information is output from the communication device 18 as detailed above.

It will be appreciated that the communication system 16 described above provides convenient and helpful information about a subsystem 12a-12o once use of the subsystem 12a-12o is detected. This information can be informative and can improve safety of the vehicle 10.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. A communication system for a vehicle with at least one subsystem having an input device with which a user supplies an input, the communication system comprising:
a communication device; and
a controller that detects the input supplied with the input device and consequently causes the communication device to output operational instruction information about the at least one subsystem.

2. The communication system of claim 1, wherein the operational instruction information is operational instruction information about how to program the at least one subsystem.

3. The communication system of claim 1, further comprising a portable device and a receiver system, wherein the receiver system detects when the portable device is within a predetermined range of the vehicle, and wherein the controller causes the communication device to output the operational instruction information when the receiver system detects that the portable device is within the predetermined range of the vehicle.

4. The communication system of claim 3, wherein the controller automatically activates when the receiver system detects that the portable device is within the predetermined range of the vehicle, and wherein the controller automatically deactivates when the receiver system detects that the portable device is outside the predetermined range of the vehicle.

5. The communication system of claim 1, further comprising a counter that records a number of times the communication device outputs the operational instruction information, and wherein the controller disables output of the operational instruction information from the communication device after the counter records a predetermined number of times.

6. The communication system of claim 1, wherein the communication device includes at least one of a speaker and a video screen.

7. The communication system of claim 1, wherein the communication device is a user-interactive communication device.

8. The communication system of claim 1, wherein the controller also causes the communication device to output warning information about the at least one subsystem when the controller detects the input supplied with the input device.

9. The communication system of claim 1, wherein the controller is a programmable controller that allows a user to program the output of the operational instruction information.

10. A vehicle comprising:
a communication device;
at least one subsystem with an input device with which a user supplies an input; and
a controller that detects the input supplied with the input device and consequently causes the communication device to output operational instruction information about the at least one subsystem.

11. The vehicle of claim 10, wherein the at least one subsystem is chosen from a group consisting of a wiper system, an interior light system, an exterior light system, a door system, a lock system, a navigation system, a climate control system, a seat adjustment system, a steering column adjustment system, an audio system, a video system, a mirror adjustment system, a safety system, an engine power delivery system, and an ignition system.

12. The vehicle of claim 10, wherein the operational instruction information is operational instruction information about how to program the at least one subsystem.

13. The vehicle of claim 10, further comprising a portable device and a receiver system, wherein the receiver system detects when the portable device is within a predetermined range of the vehicle, and wherein the controller causes the communication device to output the operational instruction information when the receiver system detects that the portable device is within the predetermined range of the vehicle.

14. The vehicle of claim 13, wherein the controller automatically activates when the receiver system detects that the portable device is within the predetermined range of the vehicle, and wherein the controller automatically deactivates when the receiver system detects that the portable device is outside the predetermined range of the vehicle.

15. The vehicle of claim 10, further comprising a counter that records a number of times the communication device outputs the operational instruction information, and wherein the controller disables output of the operational instruction information from the communication device after the counter records a predetermined number of times.

16. The vehicle of claim 10, wherein the communication device includes at least one of a speaker and a video screen.

17. The vehicle of claim 10, wherein the communication device is a user-interactive communication device.

18. The vehicle of claim 10, wherein the controller also causes the communication device to output warning information about the at least one subsystem when the controller detects the input supplied with the input device.

19. The vehicle of claim 18, wherein the communication device outputs at least one of the operational instruction information and the warning information to an exterior area of the vehicle.

20. A vehicle comprising:
a communication device with at least one of a speaker and a video screen;
at least one subsystem chosen from a group consisting of a wiper system, an interior light system, an exterior light system, a door system, a lock system, a navigation system, a climate control system, a seat adjustment system, a steering column adjustment system, an audio system, a video system, a mirror adjustment system, a safety system, an engine power delivery system, and an ignition system, the at least one subsystem having an input device with which a user supplies an input;
a portable device;
a receiver system that detects when the portable device is within a predetermined range of the vehicle; and
a controller that activates when the receiver system detects that the portable device is within the predetermined range of the vehicle, the controller deactivating when the receiver system detects that the portable device is outside the predetermined range of the vehicle, the controller detecting the input supplied with the input device and consequently causing the communication device to output operational instruction information about the at least one subsystem.
